(19) United States
(12) Patent Application Publication
(10) Pub. No.: US 2004/0260888 A1
(43) Pub. Date: Dec. 23, 2004

(54) Efficient fifo communication using semaphores

(76) Inventors: Jan Hoogerbrugge, Eindhoven (NL); Paul Stravers, Eindhoven (NL)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/495,403

(22) PCT Filed: Oct. 25, 2002
(86) PCT No.: PCT/IB02/04510

(30) Foreign Application Priority Data
Nov. 13, 2001 (EP) 012043329

(51) Int. Cl. G06F 12/00

(52) U.S. Cl. 711/147

(57) ABSTRACT

The invention relates to a method and a device for reading/writing data elements from/into a shared FIFO buffer, wherein the signalling that a data element or a storage space for a data element is available in a FIFO buffer, i.e. performing a V-operation, is not performed atomically as soon as a data element or a storage space for a data element becomes available in said FIFO buffer but to wait until L data elements or L storage spaces for L data elements have become available in said FIFO buffer before performing one signalling of the availability of the L data elements or L storage spaces for L data elements. In a sense, the signalling of the availability of the data elements or the storage spaces for data elements, i.e. performing a V-operation, is buffered until a certain amount of V-operations is collected before outputting of the signalling of the availability.

The invention relates to a method and a device for writing data elements into a shared FIFO buffer, a method and a device for reading data elements from a shared FIFO buffer, a computer system, and a corresponding computer program product.

In computer systems, coordination of processors is an important issue. In a centralised system semaphores are commonly used to solve many process coordination problems such as mutual exclusion and managing re-usable and consumable resources.

The problem of mutual exclusion is an important issue in concurrent processing. Multiple processes are often executed concurrently on one or more processors. The processors often share resources such as storage devices, input/output devices and memory. When two or more processes need to operate on the same data and memory, it becomes necessary to provide a mechanism to enforce mutual exclusive access to the resources. The mechanism is required to allow only one process to have access to a source at any one time.

Often a semaphore is used as synchronisation mechanism that mediates access to share resources. The semaphore has an associated value, which is generally set to the number of resources regulated by the semaphore. Each time the semaphore is acquired by the process the value of the semaphore is decremented by 1. After the value of the semaphore reaches zero, new attempts to acquire the semaphore are blocked until the semaphore is released by one of the processors and the value of the semaphore is incremented by 1.

The semaphore is a non-negative integer variable on which only P- and V-operations are allowed. A V-operation is used by a producer process to indicate that it has produced information for the use by the consumer process. A P-operation is used by a consumer process when it requests information produced by a producer process. The P-operation is used to enter mutual exclusion while the V-operation is used to exit mutual exclusion. A very graphic explanation of the semaphore and the P- and V-operations can be found in U.S. Pat. No. 4,928,222.

Usually, a so-called producer-consumer problem arises in concurrent processing. The basis of the producer-consumer problem is that the producer of data must have means to store said data until the consumer is ready and the consumer must not try to consume data that is not there. It appears to be impractical for the producer to produce data only when the consumer is ready to consume. If either of these processes arrive early, it is required to wait. However, if the data rates of the consumer or the producer vary during the execution of the programme or, alternatively, if the data rates of the producer or the consumer are not the same, buffering the data becomes necessary. The buffer is a segment of memory, to which both the producer and the consumer have access. If the buffer is large enough to handle peaks of data production, both producer and consumer maintain a steady high average rate of data transfer without fearing a malfunction because of occasional peaks.

When concurrent processes are linked in producer-consumer pairs and share a finite buffer where every portion is accessible to each process, the slow consumer may considerably delay the entire system. In some cases, where a consumer is blocked, the messages generated by the associate producer will invade the whole buffer and will therefore block the system. To avoid such behaviour it is known to reserve for each producer-consumer pair the adequate number of portions for a normal working and to dedicate the rest of the buffer to absorb the production peaks of the various pairs.

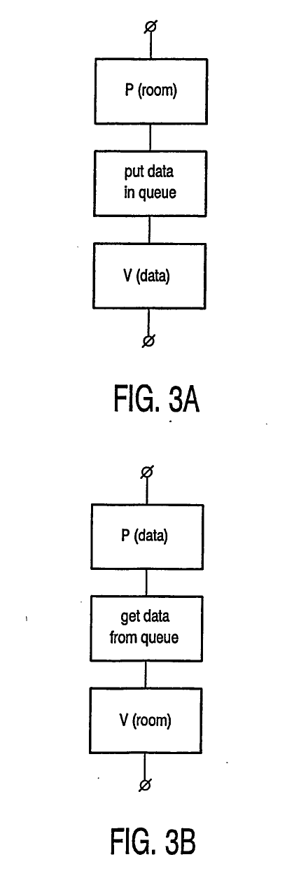

FIGS. 3A and 3B show a standard method to write into and to read from a bounded FIFO buffer which is implemented in a shared memory cached between two processors, wherein semaphores are used for synchronisation. The operation of said method to read from and to write to a bounded FIFO buffer is based on two semaphores: the semaphore ‘data’ is used to prevent reading from an empty FIFO buffer and the semaphore ‘room’ is used to prevent writing to a full FIFO buffer. The value of the semaphore ‘data’ corresponds to the number of valid data entries in the FIFO buffer while the value of the semaphore ‘room’ corresponds to the number of free positions in the FIFO buffer.

FIG. 3A shows a method to write data into said bounded FIFO buffer based on the semaphore ‘room’. A P-operation on the space in the FIFO buffer (P(room)) is performed, i.e. a request for space or room for a data element in the FIFO buffer is carried out. If there is no space or room available in the FIFO buffer the writer process has to wait. But, if there is room in the FIFO buffer, a data element is input into a queue and a V-operation (V(data), i.e. signalling that new data elements are available in the FIFO buffer, is performed.

FIG. 3B shows a method to read data from said bounded FIFO buffer based on a semaphore ‘data’. A P-operation on data elements in the FIFO buffer (P(data)), i.e. a request, if data elements are available in the FIFO buffer, is carried out. If there are no data elements available in the FIFO buffer, the reading process has to wait. But, if there are data elements in the FIFO buffer, data elements are output from a queue and a V-operation (V(data)), i.e. signalling that new space is available in the FIFO buffer, is performed.

Especially, in the case where a consumer process, i.e. a reader process, and a producer process, i.e. a writer process, are based on different processing rates, the two semaphores ‘room’ and ‘data’ are repeatedly communicated between the two process caches, resulting in an increased cache coherence traffic.

It is therefore an object of the invention to provide methods and corresponding devices for reading/writing to a shared FIFO buffer on the basis of semaphore operation which reduces the cache coherence traffic and improves the processing speed, in particular for the case when the writer and reader process has different speeds.

This object is solved by a method for writing data into the shared FIFO buffer according to claim 1, a method for reading data from the shared FIFO buffer according to claim 4, a device for writing data into the shared FIFO buffer according to claim 9, and a device for reading data from the shared FIFO buffer according to claim 10.

The invention is based on the idea to perform the signalling that a data element or a storage space for a data element is available in said FIFO buffer, i.e. performing a V-operation, not atomically as soon as a data element or a storage space for a data element becomes available in said FIFO buffer but to wait until L data elements or L storage spaces for L data elements have become available in said FIFO buffer before performing one signalling of the availability of the L data elements or L storage spaces for L data elements. In a sense, the signalling of the availability of the data elements or the storage spaces for data elements, i.e. performing a V-operation, is buffered until a certain amount of V-operations is collected before outputting of the signalling of the availability.

According to the invention, when data elements are to be written into the shared FIFO buffer, first of all, it is determined whether storage space is available in said FIFO for storing data elements therein. The input of said FIFO buffer is blocked when there is no storage space available in said FIFO buffer, while data elements are input into said FIFO buffer when there are storage space available in said FIFO buffer. The count of a write counter is incremented when the data elements are input into said FIFO buffer, wherein said count represents the number of data elements, which have been input into said FIFO buffer. After the count has reached the value of L, i.e. when L data elements have been input into said FIFO buffer, a first signalling operation is performed.

Reading data elements from a shared FIFO buffer is performed symmetrically to the writing of data elements into said shared FIFO buffer: First of all, it is determined whether a data element is available in said FIFO buffer to be read from the said FIFO buffer. The output of said FIFO buffer is blocked when there are no data elements available in said FIFO buffer, while data elements are output from said FIFO buffer when there are data elements available in said FIFO buffer. The count of a read counter is incremented when the data elements are output from said FIFO buffer, wherein said count represents the number of data elements, which have been output from said FIFO buffer. After the count has reached the value of L, i.e. when L data elements have been output from said FIFO buffer, a second signalling operation is performed.

The invention is based on the recognition that problems arise in a situation where the reader and writer process are running on different processors and the FIFO buffer is implemented in shared memory, which is cached by both processors and kept coherent by cache coherence protocol. For readers and writers having different speeds, the faster process repeatedly blocks itself (semaphore counter=0) by a P-operation being a decrement of the semaphore counter, i.e. a request for a data element or a storage space for a data element. The faster process has to be unblocked (semaphore counter>0) by a V-operation being an increment of the semaphore counter, i.e. a release of a data element or a storage space for a data element, from the slower process before it can resume its usual operation. However, in this case the slower process is forced to perform the V-operations , i.e. the release operation, in addition to the usual operation, whereby the slow process becomes even slower.

This particular problem is solved by the present invention by buffering V-operations until L V-operations have been collected and by outputting a single V-operation indicating that L data elements or L storage spaces for L data elements are available in the shared FIFO buffer. Thus, the process needs to perform less V-operations additional to the usual operation.

When an application executes read and write operations to a shared FIFO buffer in high rate, like pixels of a video stream, the pixels are directly read or written from/to the FIFO but, because L V-operations are collected, the other process (the reader in case of writing and the writer in case of reading) receives or ‘sees’ the pixels in bursts of L pixels. Hence, the signalling rate of the other process is L times lower. This enables a decoupling of the synchronization, i.e. informing the other process that data elements or storage space for data elements is available, and communication, i.e. reading or writing from/to the FIFO buffer, between a producer and the consumer process.

A further advantage of the present invention is that cache coherence traffic is reduced, since one signalling operation, indicating that L data elements are available, is used in contrast to L-times one signalling operation, indicating that one data element is available.

A still further advantage of invention is that the reader and writer are synchronised at a courser granularity than the communication. This leads to fewer semaphore operations with less machine instructions, less data traffic to keep caches consistent, and fewer blocking and unblocking of processes by the thread scheduler/operating system.

According to a preferred embodiment of the present invention, when writing data elements into a shared FIFO buffer, said first signalling operation indicates that L data elements, which have been input into said FIFO buffer, are now available to be output from said FIFO buffer. For the case of reading data elements from a shared FIFO buffer said second signalling operation indicates that L storage spaces for L data elements are now available, such that L data elements can be input into said FIFO buffer.

According to a further embodiment of the present invention, said write counter and/or said read counter is incremented from a predefined starting count onwards. It is determined whether the count of said write counter and/or the count of said read counter has reached the predefined first limit L, upon reaching the predefined first limit L the first signalling operation—when writing data elements into said FIFO buffer—or the second signalling operation—when reading data elements from said FIFO buffer—is performed. When said count of said write counter and/or said count of said read counter has reached said predefined first limit L said write counter and/or said read counter is reset to said predefined starting point.

According to still a further embodiment of the present invention the predefined starting count is 0 and the predefined first limit L is an integer which is larger than 1.

The object of the invention is furthermore solved by a device for writing data elements into a shared FIFO buffer corresponding to said method for writing data elements into a shared FIFO buffer as well as a device for reading data elements from a shared FIFO buffer corresponding to said method for reading data elements into a shared FIFO buffer.

According to the invention a computer system according to claim 11 is also provided.

Furthermore, the invention also provides a computer program product according to claim 12.

The invention will now be explained in more detail with reference to the drawings, in which:

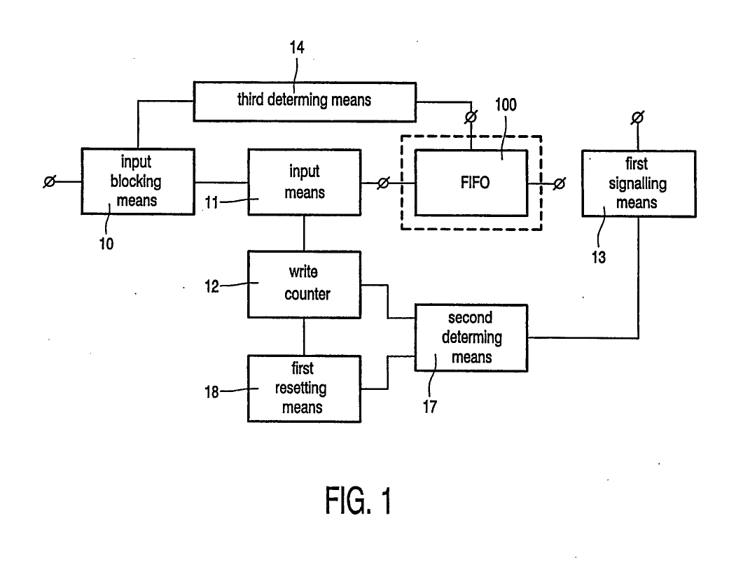

FIG. 1 shows a block diagram of a device for writing data elements into a shared FIFO buffer according to a first embodiment,

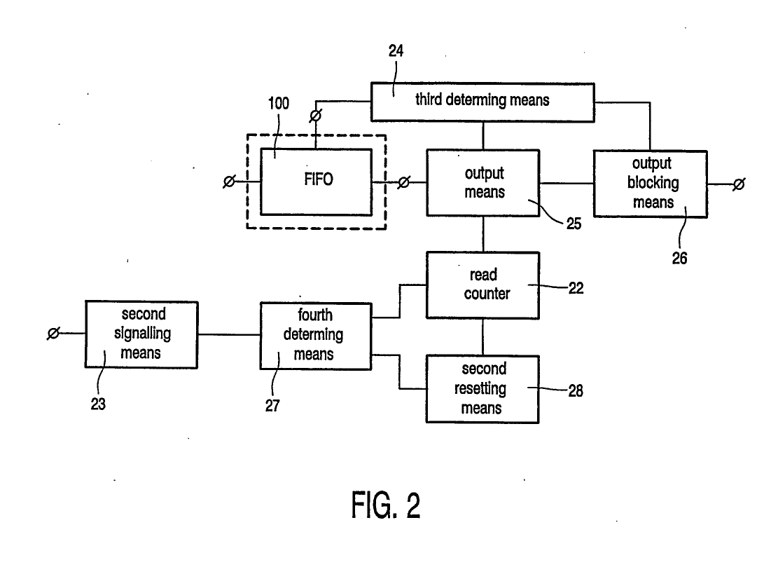

FIG. 2 shows a block diagram of a device for reading data elements from a shared FIFO buffer according to a second embodiment,

FIG. 3A shows the flow chart of a method for writing data elements into a shared FIFO buffer according to the prior art, and

FIG. 3B shows the flow chart of a method for writing data elements into a shared FIFO buffer according to her prior art.

In a first and second embodiment said FIFO buffer 100 is implemented in the shared memory in a computer system cached by at least two processors in said computer system and kept coherent by cache coherence protocol. Reader process and the writer processes are running on different processors but have access to said shared FIFO buffer 100.

FIG. 1 shows a block diagram of a device for writing data elements into the shared FIFO buffer 100 according to the first embodiment. Said device comprises an input blocking means 10, an input means 11, a first determining means 14, a write counter 12, a first signalling means 13, a second determining means 17 and a first resetting means 18.

The input blocking means 10 receives an input for the FIFO buffer 100 as input signal, and is connected to the input means 11, which is again connected to the input of the shared FIFO buffer 100. The input blocking means 10 is furthermore connected to the first determining means 14, which receives the status of the shared FIFO buffer 100 as input signal. The input means 11, which is connected to the input blocking means 10 and the input of the shared FIFO buffer 100, is also connected to the write counter 12. The write counter 12 is furthermore connected to the first resetting means 18 and the second determining means 17. The second determining means 17 is also connected to the first signalling means 13.

The first determining means 14 determines if storage space (room) is available in said FIFO buffer 100, into which data elements can be written, and outputs the determining result to the first blocking means 10. The input blocking means 10 blocks an input to said FIFO buffer 100 when the first determining means has determined that no storage space (room) is available in said FIFO buffer 100. However, if the first determining means 14 has determined that storage space (room) is available in said FIFO buffer 100, the input means inputs a data element into said FIFO buffer 100. Thereafter, the input means 11 informs the write counter 12 that one data element has been input into said FIFO buffer 100. The write counter 12 increments the count thereof if it has been informed by the input means 11 that one data element has been input into said FIFO buffer 100. Hence, the count of the write counter 12 indicates the number of the data elements input into said FIFO buffer 100.

The second determining means 17 determines whether the count of the write counter 12 has reached a first limit L. When the count of the write counter 12 has reached the first limit L, the second determining means 17 informs the first signalling means 13 and the first resetting means 18 that the count of the write counter 12 has reached the first limit L. The first signalling means 13 performs a first signalling operation when it has been notified by the second determining means 17 that the count of the write counter 12 has reached the first limit L. The first signalling operation indicates that L data elements are now available to be output from said FIFO buffer 100, i.e. the first signalling operation represents one V-operation regarding the available L data elements.

When the first resetting means 18 is notified by the second determining means 17 that the count of the write counter 12 has reached the first limit L—and preferably after the first signalling operation is carried out—the first resetting means 18 resets the count of the write counter 12 to zero. Accordingly, the buffering of the first signalling operation is initiated again after the count of the write counter 12 has reached the first limit L.

FIG. 2 shows a block diagram of a device for reading data elements from said shared FIFO buffer 100 according to the second embodiment. Said device comprises an output blocking means 26, an output means 25, a third determining means 24, a read counter 22, a second signalling means 23, a fourth determining means 27 and a second resetting means 28.

The output blocking means 26 receives an output request or a read request for the FIFO buffer as input signal, and is connected to the output means 25, which is again connected to the output of the shared FIFO buffer 100. The output blocking means 26 is furthermore connected to the third determining means 24, which receives the status of the shared FIFO buffer 100 as input signal. The output means 25, which is connected to the output blocking means 26 and the output of the shared FIFO buffer 100, is also connected to the read counter 22. The read counter 22 is furthermore connected to the second resetting means 28 and the fourth determining means 27. The fourth determining means 27 is also connected to the second signalling means 13.

The third determining means 24 determines if data elements are available in said FIFO buffer 100 to be read from said FIFO buffer 100, and outputs of the determining result to the output blocking means 126. The output blocking means 26 blocks the output from said FIFO buffer 100 when the third determining means 24 has determined that no data elements are available in said FIFO buffer 100. However, if the third determining means 24 has determined that data elements are available in said FIFO buffer 100, the output means 25 outputs or extracts a data element from said FIFO buffer 100. The output means 25 informs the read counter 22 that one data element has been output from said FIFO buffer 100. The read counter 22 increments the count thereof, if it has been informed by the output means 25 that one data element has been output from said FIFO buffer 100. Hence, the count of the read counter 12 indicates the number of the data elements output from said FIFO buffer 100 and therefore also the number of available storage spaces for data elements in said FIFO buffer 100.

The fourth determining means 27 determines whether the count of the read counter 22 has reached a first limit L. When the count of the read counter 22 has reached the first limit L the fourth determining means 27 informs the second signalling means 23 and the second resetting means 28 that the count of the read counter 22 has reached the first limit L. The second signalling means 23 performs a second signalling operation when it has been notified by the fourth determining means 27 that the count of the read counter 22 has reached the first limit L. The second signalling operation indicates that L data elements have been output from the FIFO buffer 100 by the output means 25 and that there are now L storage spaces available to in said FIFO buffer 100 to be filled with another L data elements, i.e. the second signalling operation represents one V-operation on the available L storage spaces.

When the second resetting means 28 is notified by the fourth determining means 17 that the count of the read counter 22 has reached the first limit L—and preferably after the second signalling operation is carried out—the second resetting means 28 resets the count of the read counter 22 to zero. Accordingly, the buffering of the second signalling operation is initiated again after the count of the read counter 22 has reached the first limit L.

The device for reading and the device for writing data elements from/into said shared FIFO buffer 100 may be implemented in a computer system based on in concurrent processing or in a computer system based on multi task processing.

Care must be taken, when V-operations on available data elements in said FIFO buffer 100 are buffered as suggested in the first embodiment of the present invention, since deadlock may occur. For example, if a process A sends a token to another process B and then starts waiting for a reply from the process B, deadlock may occur if the process B does not get notified of the token send by the process A because the V-operation on available data elements are buffered until L data elements are available to be output from said FIFO buffer 100. This can be avoided by implementing a block handler for each process. The block handler is executed by the overall process scheduler right before a process is blocked, for example, because a semaphore counter is zero. The block handler is implemented by performing said first signalling operations, i.e. notifying that data elements are available in the FIFO buffer to be read by a reader process, for all FIFO buffers it is writing to.

Summarising it can be said that, the two processors are running processes that communicate with each other by means of FIFO's that are stored in shared memory. The interconnection is typically a bus. Often, the processors include caches which have to be kept coherent by means of a cache coherence protocol that is implemented by the processors and the interconnection. Software communication implies also synchronisation: the reader should not read before data is available and the writer should not write before free space is available. The goal of the invention is to synchronise the reader and writer at a courser granularity than the communication. This leads to fewer semaphore operations, less data traffic to keep caches consistent, and fewer blocking and unblocking of processes by the thread scheduler/operating system.

1. Method for writing data elements into a shared FIFO buffer (100) on the basis of semaphore operations, comprising the steps of:
a) determining if storage space (room) is available in said FIFO buffer (100) to store data elements therein;
b) blocking the input of said FIFO buffer (100) if it has been determined in step a) that no storage space (room) is available in said FIFO buffer (100);
c) inputting data elements into said FIFO buffer (100), if it has been determined in step a) that storage space (room) is available in said FIFO buffer (100);
d) incrementing the count of a write counter (12), when a data element is input in step c), said count indicating the number of the data elements input in said FIFO buffer (100); and
e) performing a first signalling operation when said count of said writer counter (12) has been incremented by L.

2. Method according to claim 1, wherein
said first signalling operation in step e) indicates that L data elements input in said FIFO buffer (100) in step c) are available to be output from said FIFO buffer (100).

3. Method according to claim 1, wherein
said step d) comprises the step of incrementing said count of said write counter (12) from a predefined starting count;
said method further comprising the steps of:
f) determining whether said count of said write counter (12) has reached a predefined first limit L,
g) resetting said count of said write counter (12) to said predefined starting point after step f).

4. Method for reading data elements from a shared FIFO buffer (100) on the basis of semaphore operations, comprising the steps of:
a) determining if data elements are available in said FIFO buffer (100) to be read from said FIFO buffer (100);
b) blocking the output of said FIFO buffer (100) if it has been determined in step a) that no data elements are available in said FIFO buffer (100) to be read from said FIFO buffer (100);
c) outputting data elements from said FIFO buffer (100), if it has been determined in step a) that data elements are available in said FIFO buffer (100) to be read from said FIFO buffer (100);
d) incrementing the count of a reader counter (22), when a data element is output from said FIFO buffer (100) in step c), said count indicating the number of the data elements output from said FIFO buffer (100); and
e) performing a second signalling operation when said count of said read counter (17) has been incremented by L.

5. Method according to claim 4, wherein
said second signalling operation in step e) indicates that L storage spaces (room) are available in said FIFO buffer (100) to store L data elements.

6. Method according to claim 4, wherein
said step d) further comprises the step of incrementing said count of said read counter (17) from a predefined starting count;
said method further comprising the steps of:
f) determining whether said count of said read counter (12) has reached a predefined first limit L,
g) resetting said count of said read counter (12) to said predefined starting point after step f).

7. Method according to claim 3, wherein
said the predefined starting count is zero.

8. Method according to claim 1, wherein
said first limit L being an integer which is larger than one.

9. Device for writing data elements into a shared FIFO buffer (100) on the basis of semaphore operations, comprising:
first determining means (14) for determining if storage space (room) is available in said FIFO buffer (100) to store data elements therein;
input blocking means (10) for blocking the input of said FIFO buffer (100) when said first determining means (14) has determined that no storage space (room) is available in said buffer (100);
input means (11) for inputting data elements into said FIFO buffer (100), when said first determining means (14) has determined that storage space (room) is available in said FIFO buffer (100);
write counter (12) for incrementing the count thereof when data elements are input in step c), said count indicating the number of the data elements input in said FIFO buffer (100); and
first signalling means (13) for performing a first signalling operation when said count of said writer counter (12) has been incremented by L.

10. Device for reading data elements from a shared FIFO buffer (100) on the basis of semaphore operations, comprising:
third determining means (24) for determining if data elements are available in said FIFO buffer (100) to be read from said FIFO buffer (100);
output blocking means (25) for blocking the output of said FIFO buffer (100) when said third determining means (24) has determined that no data elements are available in said FIFO buffer (100);
output means (25) for outputting data elements from said FIFO buffer (100), when said third determining means (24) has determined that data elements are available in said FIFO buffer (100);
reader counter (17) for incrementing the count thereof when said output means (25) outputs data elements from said FIFO buffer (100), wherein said count indicating the number of the data elements output from said FIFO buffer (100); and
second signalling means (23) for performing a second signalling operation when said count of said read counter (17) has been incremented by L.

11. Computer system for concurrent processing, comprising:
a device for writing data elements into a shared FIFO buffer (100) using semaphore operations according to of claim 9, and/or
a device for reading data elements into a shared FIFO buffer (100) using semaphore operations according to claim 10.

12. Computer program product comprising computer program code means for causing a computer to perform the steps of the method as claimed in when said computer program is run on a computer.
